(19) United States
(12) Patent Application Publication
(10) Pub. No.: US 2026/0302092 A1
(43) Pub. Date: Oct. 1, 2026

(54) CAPACITOR AND METHOD FOR PRODUCING A CAPACITOR

(71) Applicant: TDK Electronics AG, Munchen (DE)

(72) Inventors: László Dobai, Szeleste (HU); Gábor Székely, Zalaszentgrót (HU); István Varga, Szombathely (HU)

(21) Appl. No.: 19/477,472

(22) PCT Filed: Apr. 18, 2024
(86) PCT No.: PCT/EP2024/060487

§ 371 Date: Oct. 21, 2025

(30) Foreign Application Priority Data
Apr. 25, 2023 (DE) 102023110552.3

(51) Int. Cl. H01G 9/12; H01G 9/00; H01G 9/10; H01G 9/145

(52) U.S. Cl. CPC H01G 9/12; H01G 9/0029; H01G 9/10; H01G 9/145

(57) ABSTRACT

In an embodiment a capacitor includes a capacitive element arranged in a case that is sealed with a cover, wherein the case or the cover includes at least one through hole that is covered with a gas dissipation element configured to reduce a gas pressure inside the capacitor, wherein the gas dissipation element is arranged on an outer surface or on an inner surface of the case or the cover, wherein the outer surface or the inner surface includes a surface structuring that is configured to improve a bonding between the gas dissipation element and the outer surface or the inner surface, respectively, and wherein the gas dissipation element is chemisorbed onto the case or the cover.

### CROSS-REFERENCE TO RELATED APPLICATIONS

This patent application is a national phase filing under section 371 of PCT/EP2024/060487, filed Apr. 18, 2024, which claims the priority of German patent application no. 102023110552.3, filed Apr. 25, 2023, each of which is incorporated herein by reference in its entirety.

### TECHNICAL FIELD

A capacitor and a method for producing a capacitor are specified herein.

### BACKGROUND

Capacitors with high CV factors and long lifetimes may be used in switch mode power supplies, for example. Here, the CV factor corresponds to a product of the capacitance and the operating voltage divided by a volume of the capacitor and determines a volumetric efficiency of the capacitor. In particular, the lifetime of high CV capacitors is limited by gas generation or electrolyte degradation. For example, a capacitance of an anode element is inversely proportional to a forming voltage of an anodic oxide layer that is in turn proportional to a thickness of the anodic oxide layer. With decreasing forming voltage a leakage current through the anodic oxide layer may increase exponentially, however, thereby increasing an amount of gas that can be generated inside the capacitor. Moreover, high CV capacitors may not have enough free volumetric space to accommodate such gases. Consequently, the pressure inside the capacitor can increase during operation, which may lead to a damaging or destruction of the capacitor and a corresponding shortened lifetime. For example, document DE 10 2015 119 844 A1 discloses a capacitor with a safety vent.

### SUMMARY

Embodiments provide a capacitor with an increased lifetime. Further embodiments provide a method for producing a capacitor with an increased lifetime.

According to an embodiment, the capacitor comprises a capacitive element arranged in a case that is sealed with a cover.

In particular, the capacitive element is configured to store electric charges during operation of the capacitor. For example, the capacitive element can be charged and discharged during operation of the capacitor. For example, the capacitive element comprises a cathode element and an anode element that are physically separated by a dielectric element. The cathode element and the anode element can be electrically contacted by electrically conductive elements, such as wires or leads.

For example, the case is configured to mechanically stabilize the capacitor. In particular, the case comprises a cavity where the capacitive element is arranged. For example, the case has an opening for inserting the capacitive element into the cavity during production of the capacitor. For example, the case has a cylindrical form with a bottom surface and an open end face opposite to the bottom surface, wherein the open end face forms the opening. In particular, the case protects the capacitive element from external forces or harmful substances that might damage the capacitor during operation.

The case can be configured to electrically isolate the capacitive element from the environment outside the case. Alternatively, the case can be configured for electrically contacting the capacitive element. For example, the case is electrically conductive and is electrically connected to the anode element or the cathode element. Moreover, the case can be configured as a heat sink, such that heat generated by the capacitive element during operation is efficiently transferred and dissipated away from the capacitive element. For example, the capacitive element is in thermal contact with the case.

For example, the cover and the case form a sealed cavity, in which the capacitive element is arranged. In particular, the cavity is sealed by arranging or mounting the cover on the opening of the case. Moreover, at least one electrically conductive element, such as a wire or lead, for electrically contacting the capacitive element can be arranged in the cover or integrated into the cover. For example, the cover comprises or consists of a metal, a plastic, a glass, a hard paper, or rubber.

According to an embodiment of the capacitor, the case or the cover comprises at least one through hole that is covered with a gas dissipation element configured for reducing a gas pressure inside the capacitor during operation of the capacitor.

For example, the case or the cover comprises one, two, three or a plurality of through holes. In particular, if the case or the cover comprises two or more through holes, the through holes can be grouped together in one region of the case or in one region of the cover. For example, a distance between neighboring through holes is smaller than a diameter of one of the through holes. In particular, the plurality of through holes forms a regular array. One, two or more through holes can also be arranged in the case and in the cover, for example.

In the following, features of one through hole are specified. These features can apply to one through hole, to a majority of through holes, or to all through holes, for example. In particular, the through hole extends completely through the case, such that a gas can escape from the cavity via the through hole. For example, the through hole has circular, elliptical, oval, curved, square, rectangular or polygonal cross-section. A diameter of the through hole is between 0.1 mm and 10 mm, or preferably between 0.5 mm and 6 mm, for example. Here and in the following, the diameter refers to a maximum linear dimension of the cross-section of the through hole.

For example, the through hole is arranged at a bottom surface of the case. Here and in the following, the bottom surface is arranged opposite to the opening of the cavity, through which the capacitive element is inserted into the cavity during production of the capacitor. In particular, the bottom surface is flat. Alternatively or in addition, the through hole is arranged on a lateral surface of the case. In particular, the lateral surface is arranged crosswise or perpendicular to the bottom surface. For example, the lateral surface is curved.

In particular, the gas dissipation element completely covers the at least one through hole. For example, the gas dissipation element completely covers the one, two, or more through holes or the plurality of through holes. For example, the gas dissipation element completely covers the array of through holes. For example, the gas dissipation element is arranged or disposed directly on or above the at least one through hole. In other words, the gas dissipation element is not arranged completely inside the at least one through hole. If both, the case and the cover comprise through holes, the capacitor can also comprise two or more gas dissipation elements, at least one for the case and one for the cover, for example.

In particular, gas that can be generated during operation of the capacitor inside the sealed cavity formed by the case and the cover can escape from the cavity via the at least one through hole and the gas dissipation element. For example, if a partial pressure of the gas inside the cavity is larger than the partial pressure of the gas outside the cavity, the gas can diffuse or permeate out of the cavity through the gas dissipation element. In particular, liquids such as electrolytes cannot permeate through the gas dissipation element. In other words, liquids are hermetically sealed inside the cavity, for example.

According to at least one further embodiment of the capacitor, the gas dissipation element is arranged on an outer surface or on an inner surface of the case or the cover. Here and in the following, the inner surface is a surface facing the capacitive element, whereas the outer surface is a surface opposite to the inner surface. In particular, neither the outer surface nor the inner surface comprises a sidewall of the through hole.

According to at least one further embodiment of the capacitor, the outer surface or the inner surface comprises a surface structuring that is configured to improve a bonding between the gas dissipation element and the outer surface or the inner surface, respectively. For example, the surface structuring completely encloses the through hole. For example, the surface structuring comprises a region of the surface with an increased surface roughness. For example, the surface structuring comprises or consists of one or more recesses. In particular, the recess completely surrounds the through hole, or the through hole is formed inside the recess. For example, a depth of the recess is at most one half of a thickness of the case or the cover.

According to at least one further embodiment of the capacitor, the gas dissipation element is chemisorbed onto the case or the cover. For example, no adhesive is used to attach the gas dissipation element onto the outer surface or onto the inner surface. In particular, direct chemical bonds are formed between the gas dissipation element and the case or the cover, such that a liquid-tight seal is formed. The chemical bonds can be primary, secondary or van-der-Waals bonds, for example.

According to an embodiment, the capacitor comprises the capacitive element arranged in the case that is sealed with the cover, wherein the case or the cover comprises at least one through hole that is covered with the gas dissipation element configured for reducing a gas pressure inside the capacitor during operation of the capacitor, wherein the gas dissipation element is arranged on an outer surface or on an inner surface of the case or the cover, wherein the outer surface or the inner surface comprises a surface structuring that is configured to improve a bonding between the gas dissipation element and the outer surface or the inner surface, respectively, and wherein the gas dissipation element is chemisorbed onto the case or the cover.

The capacitor disclosed herein is based on the idea to extend the lifetime of high CV capacitors by providing a gas dissipation element that reduces a pressure inside the capacitor during operation. For example, during charging or discharging of the capacitor, electrochemical process can generate gases, such as H₂, CO₂, ethane, ethane or other low molecular weight gases, inside the capacitor. Consequently, the pressure inside the capacitor can increase during operation. If the pressure inside the capacitor becomes too large, the capacitor can be damaged or break, for example. Advantageously, the gas dissipation element allows such gases to escape from the capacitor, thereby reducing the pressure inside the capacitor. Accordingly, the lifetime of the capacitor is increased. Moreover, liquid electrolytes remain sealed inside the capacitor, for example.

Furthermore, compared to a gas dissipation element that is mechanically clamped inside the through hole, for example, the production process can be simplified by arranging the gas dissipation element such that it covers the through hole, thereby reducing production costs. Moreover, a total thickness of the case and the gas dissipation element may be advantageously reduced, as no elements for clamping the gas dissipation element inside the through hole are necessary, for example.

According to at least one further embodiment of the capacitor, the gas dissipation element comprises or consists of a gas diffusive layer. In particular, gases generated inside the capacitor during operation can diffuse or permeate through the gas diffusive layer or imbue the gas diffusive layer. A gas permeability for H 2 of the gas dissipation element is between 10¹⁰ cm²/(s*atm) and 10¹³ cm² /(s*atm), for example.

According to at least one further embodiment of the capacitor, the gas dissipation element comprises or consists of at least one of the following materials: a polymer, a metal organic framework, or silicon. For example, the gas dissipation element comprises or consists of a gas diffusive layer, wherein the latter comprises or consists of a polymer, a silicone, a metal organic framework, silicon, silicon nitride, or silicon carbide, for example.

According to at least one further embodiment of the capacitor, the gas dissipation element extends at least partially into the through hole. For example, the gas diffusive layer comprises a polymer that covers the through hole and partially or fully extends into the through hole. For example, the through hole can be partially or completely filled with the polymer.

According to at least one further embodiment of the capacitor, a thickness of the gas dissipation element is between 0.1 mm and 2.5 mm, inclusive. The thickness of the gas dissipation element can also take values between 0.1 mm and 3 mm, inclusive. For example, a thickness of the gas diffusive layer is between 0.1 mm and 2.5 mm. In particular, the thickness refers to a spatial dimension in a direction parallel to the through hole. In other words, the thickness refers to a spatial dimension in a direction parallel to a central axis of the through hole.

According to at least one further embodiment of the capacitor, a total thickness of the case and the gas dissipation element is at most 2.5 mm, if the case comprises the through hole. In particular, the total thickness refers to a combined thickness of the gas dissipation element and the case.

According to at least one further embodiment of the capacitor, a total thickness of the cover and the gas dissipation element is at most 3.5 mm, if the cover comprises the through hole. In particular, the total thickness refers to a combined thickness of the gas dissipation element and the cover.

According to at least one further embodiment of the capacitor, molecules with a molecular weight below 60 Da can penetrate through the gas dissipation element. In particular, H₂ can penetrate or permeate through the gas dissipation element.

According to at least one further embodiment of the capacitor, the case comprises or consists of a metal, such as aluminum. Alternatively or in addition, the case comprises or consists of a plastic or a polymer, for example.

According to at least one further embodiment of the capacitor, the capacitive element is a winding element comprising a liquid electrolyte with a water concentration of at least 2% by weight. In particular, the winding element comprises cathode and anode foils that are wound around each other and that are separated by a dielectric. For example, the capacitor as an aluminum electrolytic capacitor. The winding element is partially or fully immersed in the liquid electrolyte, for example.

According to at least one further embodiment of the capacitor, the capacitor has a volumetric filling factor of at least 75%. In particular, the volumetric filling factor refers to a ratio between a volume of the winding element and a volume of the cavity formed by the case and the cover.

According to at least one further embodiment of the capacitor, the capacitor has an anode foil forming factor of at most 1.55. In particular, the anode foil forming factor corresponds to a ratio between a forming voltage of an anodic oxide layer and a nominal voltage of the capacitor. The nominal voltage refers to a maximum operating voltage applied between the anode and the cathode of the capacitor during operation, for example. In particular, the higher the anode foil forming factor, the longer is a lifetime of the capacitor.

For example, the anode element, such as the anode foil, comprises the anodic oxide layer on its surface and the forming voltage of the anodic oxide layer corresponds to a thickness of the anodic oxide layer. For example, the forming voltage is measured by submerging the anode element together with a counter electrode in a liquid electrolyte and applying a constant electrical current to the anode element. The constant electrical current is applied until the voltage between the anode element and the counter electrode saturates to a maximum value, which corresponds to the forming voltage.

In particular, the forming voltage is measured using a liquid electrolyte comprising demineralized water, boric acid and ammonium pentaborate at a temperature of 90° C. in a stainless steel tank that acts as counter electrode. Moreover, the anode element has an area of 20 cm² and the constant electrical current has a current density of 0.5 mA/cm², for example.

According to at least one further embodiment of the capacitor, a nominal voltage of the capacitor is at least 350 V.

According to at least one further embodiment of the capacitor, the gas dissipation element is electrically insulating.

According to at least one further embodiment of the capacitor, the gas dissipation element has a dielectric strength of at least 1.2 kV/mm.

Further, a method for producing a capacitor is specified herein. In particular, the method can be used to produce a capacitor as specified above. All features of the capacitor are also disclosed for the method for producing a capacitor, and vice versa.

According to an embodiment of the method for producing a capacitor, the case and the cover are provided, wherein the case or the cover comprises at least one through hole. It is also possible that the case and the cover each comprise at least one through hole.

According to a further embodiment of the method for producing a capacitor, the at least one through hole is covered with the gas dissipation element, wherein the gas dissipation element is configured for reducing a gas pressure inside the capacitor during operation of the capacitor. If the case and the cover each comprise at least one through hole, at least two separate gas dissipation elements can be arranged to cover the through holes in the case and in the cover, respectively.

According to a further embodiment of the method for producing a capacitor, the gas dissipation element is chemisorbed onto the outer surface or the inner surface of the case or the cover, wherein the outer surface or the inner surface comprises the surface structuring that is configured to improve a bonding between the gas dissipation element and the outer surface or the inner surface, respectively.

According to a further embodiment of the method for producing a capacitor, the capacitive element is arranged in the case. For example, the capacitive element comprises a winding element with anode and cathode foils that are wound around each other. In particular, the case comprises the cavity and the winding element is inserted into the cavity.

According to a further embodiment of the method for producing a capacitor, the case is sealed with the cover. For example, the cover is pressed onto the case or into the cavity. For example, the cover is pressed into the cavity with a curling tool, such that an edge of the case is curled towards the cover upon pressing the cover into the cavity. In particular, the cover is pressed onto the case or into the cavity, such that a liquid-proof or gas-proof seal is formed between the case and the cover.

According to an embodiment, the method for producing a capacitor comprises the following steps:
a) providing the case and the cover, wherein the case or the cover comprises at least one through hole;
b) covering the at least one through hole with the gas dissipation element, wherein the gas dissipation element is configured for reducing a gas pressure inside the capacitor during operation of the capacitor, wherein the gas dissipation element is chemisorbed onto an outer surface or onto an inner surface of the case or the cover, and wherein the outer surface or the inner surface comprises a surface structuring that is configured to improve a bonding between the gas dissipation element and the outer surface or the inner surface, respectively;
c) arranging the capacitive element in the case; and
d) sealing the case with the cover.

Preferably, the steps of the method for producing a capacitor are performed in the order from a) to d) specified above.

According to a further embodiment of the method, the step of covering the at least one through hole comprises gluing the gas dissipation element onto the outer surface or onto the inner surface of the case or the cover, such that the through hole is covered. For example, an adhesive is used to glue the gas dissipation element onto the outer surface or onto the inner surface of the case or the cover.

According to a further embodiment of the method, the step of covering the at least one through hole comprises directly bonding the gas dissipation element with an outer surface or an inner surface of the case or the cover, such that the through hole is completely covered. In particular, no adhesive is used to form a liquid-tight seal between the outer surface and the gas dissipation element, or between the inner surface and the gas dissipation element. For example, a primary, secondary or van-der-Waals bond is formed between the gas dissipation element and the case or between the gas dissipation element and the cover.

According to a further embodiment of the method, the gas dissipation element is a gas diffusive layer that is chemisorbed onto the case or the cover during the step of covering the at least one through hole. In particular, a chemical reaction bonds the gas diffusive layer with the case or the cover during an adsorption of the layer on the case or the cover.

According to a further embodiment of the method, the step of covering the at least one through hole comprises disposing the gas dissipation element across the through hole in a viscous form and subsequently curing or hardening the gas dissipation element. For example, the gas dissipation element consists of a gas diffusive layer that comprises a resin. For example, the resin is applied across the through hole and cured using heat or ultraviolet radiation.

### BRIEF DESCRIPTION OF THE DRAWINGS

Further advantageous embodiments and further embodiments of the capacitor and the method for producing a capacitor become apparent from the following exemplary embodiments described in connection with the figures.

FIGS. 1 to 6 show schematic cross sections of capacitors according to different exemplary embodiments.

Elements that are identical, similar, or have the same effect, are denoted by the same reference signs in the figures. The figures and the proportions of the elements shown in the figures are not to be regarded as true to scale. Rather, individual elements may be shown exaggeratedly large for better representability and/or better understanding.

### DETAILED DESCRIPTION OF ILLUSTRATIVE EMBODIMENTS

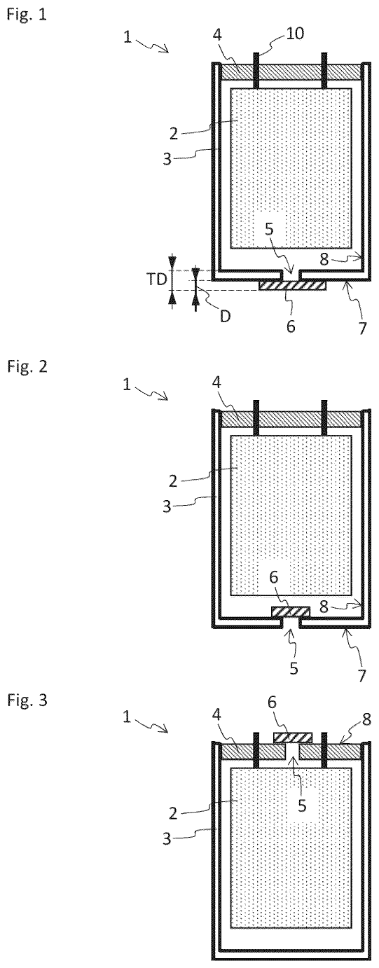

The capacitor 1 according to the exemplary embodiment in FIG. 1 comprises a capacitive element 2 arranged in a case 3 that is sealed with a cover 4. The case 3 has a cylindrical shape and consists of a metal, such as aluminium. The cover 4 consists of rubber, for example. Moreover, two electrically conductive elements 10 for electrically contacting the capacitive element 2 are embedded into the cover 4.

The case 3 has a through hole 5 in a bottom surface opposite to the cover 4. The through hole 5 has a circular shape with a diameter between 1 mm and 5 mm. The through hole 5 is covered with a gas dissipation element 6 that is configured for reducing a gas pressure inside the capacitor 1 during operation. In particular, a gas such as H₂, that is generated by electrochemical processes during charging or discharging the capacitive element 2 during operation of the capacitor 1, can escape from inside the capacitor 1 via the through hole 5 and the gas dissipation element 6.

The gas dissipation element 6 is a gas diffusive layer 6 consisting of a silicone, for example. The gas dissipation element 6 is chemisorbed onto an outer surface 7 of the case 3. The outer surface 7 of the case 3 is opposite to an inner surface 8 of the case 3, wherein the inner surface 8 faces the capacitive element 2. In particular, the gas dissipation element 6 is not clamped inside the through hole 5, for example. Since no mechanical elements for clamping the gas dissipation element 6 are required, a total thickness TD of the case 3 and the gas dissipation element 6 can be advantageously reduced. In particular, the total thickness TD of the case 3 and the gas dissipation element 6 is at most 2.5 mm, whereas a thickness D of the gas dissipation element 6 is between 0.1 mm and 2.5 mm.

Compared to the capacitor 1 described with regard to the exemplary embodiment of FIG. 1, the capacitor 1 according to the exemplary embodiment in FIG. 2 comprises a gas dissipation element 6 that is arranged on an inner surface 8 of the case 3. By arranging the gas dissipation element 6 on the inner surface 8 of the case 3, a probability of de-bonding or de-lamination of the case 3 and the gas dissipation element 6 during operation of the capacitor 1 may be reduced, for example.

Compared to the capacitor 1 described with regard to the exemplary embodiment of FIG. 1, the capacitor 1 according to the exemplary embodiment in FIG. 3 has a through hole 5 arranged in the cover 4, rather than in the case 3. The gas dissipation element 6 is bonded onto an outer surface 8 of the cover 4 that is facing away from the capacitive element 2.

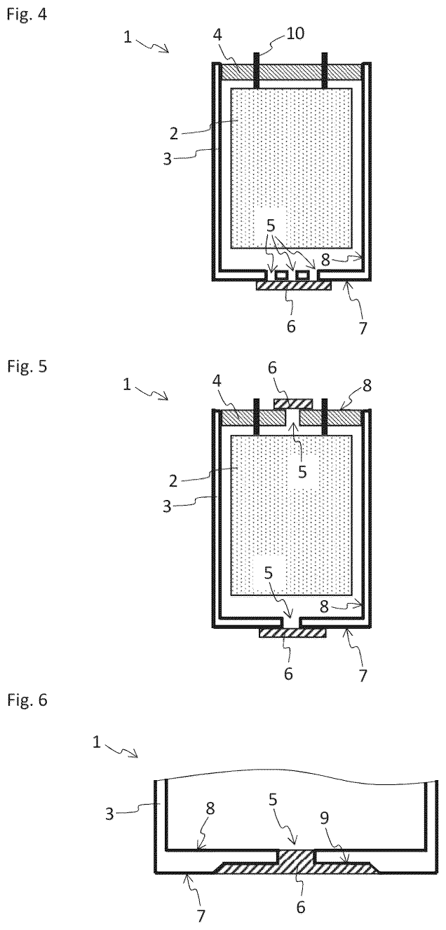

Compared to the capacitor 1 described with regard to the exemplary embodiment of FIG. 1, the capacitor 1 according to the exemplary embodiment in FIG. 4 has a plurality of through holes 5 arranged in the bottom surface of the case 3. The plurality of through holes 5 are arranged in the form of a regular array. The plurality of through holes 5 are completely covered by the gas dissipation element 6.

By arranging a plurality of through holes 5 in the case 3, a cross-sectional area of each of the plurality of through holes 5 can be reduced compared to a single through hole 5, while an overall gas permeability of the plurality of through holes 5 can be maintained. In particular, by arranging a plurality of through holes 5 instead of a larger, single through hole 5 in the case, a mechanical stability of the case 3 can be advantageously increased.

Compared to the capacitor 1 described with regard to the exemplary embodiment of FIG. 1, the capacitor 1 according to the exemplary embodiment in FIG. 5 has an additional through hole 5 arranged in the cover 4, that is fully covered by a second gas diffusive element 6.

FIG. 6 shows a part of a case 3 of a capacitor 1 according to a further exemplary embodiment. Similar to the capacitor 1 described in connection with FIG. 1, the capacitor shown in FIG. 6 has a through hole 5 arranged in the bottom surface of the case 3. In addition, the outer surface 7 of the case has a surface structuring 9 in the form of a recess 9 that completely encloses the through hole 5.

The gas dissipation element 6 is a gas diffusive layer that is formed inside the recess 9, such that it completely covers the through hole 5. Moreover, the gas dissipation element 6 extends into the through hole 5 and completely fills the through hole 5. The gas dissipation element 6 consists of a silicone that is chemisorbed onto the case 3. In particular, a silicone resin is disposed in the recess 9 and in the through hole 5 and is subsequently cured, thereby forming the gas dissipation element 6.

The invention is not restricted to the exemplary embodiments by the description on the basis of said exemplary embodiments. Rather, the invention encompasses any new feature and also any combination of features, which in particular comprises any combination of features in the patent claims and any combination of features in the exemplary embodiments, even if this feature or this combination itself is not explicitly specified in the patent claims or exemplary embodiments.

1-16. (canceled)

17. A capacitor comprising:
a capacitive element arranged in a case that is sealed with a cover,
wherein the case or the cover comprises at least one through hole that is covered with a gas dissipation element configured to reduce a gas pressure inside the capacitor,
wherein the gas dissipation element is arranged on an outer surface or on an inner surface of the case or the cover,
wherein the outer surface or the inner surface comprises a surface structuring that is configured to improve a bonding between the gas dissipation element and the outer surface or the inner surface, respectively, and
wherein the gas dissipation element is chemisorbed onto the case or the cover.

18. The capacitor according to claim 17, wherein the gas dissipation element comprises or consists of a gas diffusive layer.

19. The capacitor according to claim 17, wherein the gas dissipation element comprises at least one of a polymer, a metal organic framework, or silicon.

20. The capacitor according to claim 17, wherein the gas dissipation element extends at least partially into the through hole.

21. The capacitor according to claim 17, wherein a thickness of the gas dissipation element is between 0.1 mm and 2.5 mm, inclusive.

22. The capacitor according to claim 17, wherein a total thickness of the case and the gas dissipation element is at most 2.5 mm when the case comprises the through hole.

23. The capacitor according to claim 17, wherein a total thickness of the cover and the gas dissipation element is at most 3.5 mm when the cover comprises the through hole.

24. The capacitor according to claim 17, wherein gas dissipation element is configured to let molecules with a molecular weight below 60 Da pass.

25. The capacitor according to claim 17, wherein the case comprises a metal.

26. The capacitor according to claim 17, wherein the capacitive element is a winding element comprising a liquid electrolyte with a water concentration of at least 2% by weight.

27. The capacitor according to claim 17, wherein the capacitor has a volumetric filling factor of at least 75%.

28. The capacitor according to claim 17, wherein the capacitor has an anode foil forming factor of at most 1.55.

29. The capacitor according to claim 17, wherein the capacitor is operable at a nominal voltage of at least 350 V.

30. The capacitor according to claim 17, wherein the gas dissipation element is electrically insulating.

31. The capacitor according to claim 29, wherein the gas dissipation element has a dielectric strength of at least 1.2 kV/mm.

32. A method for producing a capacitor, the method comprising:
providing a case and a cover, wherein the case or the cover comprises at least one through hole;
covering the at least one through hole with a gas dissipation element, wherein the gas dissipation element is configured for reducing a gas pressure inside the capacitor, wherein the gas dissipation element is chemisorbed onto an outer surface or onto an inner surface of the case or the cover, and wherein the outer surface or the inner surface comprises a surface structuring that is configured for improving a bonding between the gas dissipation element and the outer surface or the inner surface, respectively;
arranging a capacitive element in the case; and
sealing the case with the cover.

33. The method according to claim 32, wherein covering the at least one through hole comprises:
disposing the gas dissipation element across the through hole in a viscous form; and
subsequently curing or hardening.
